(19) United States
(12) Patent Application Publication
(10) Pub. No.: US 2025/0135599 A1
(43) Pub. Date: May 1, 2025

(54) ERGONOMIC ADJUSTABLE GRIP FOR A HAND-HELD POWER TOOL

(71) Applicant: Harbor Freight Tools USA, Inc., Calabasas, CA (US)

(72) Inventors: Jeremy Douglas Leasure, Lexington, TN (US); Markus Henry Kleis, Yorba Linda, CA (US); Curtis Henry Watenpaugh, Fontana, CA (US)

(21) Appl. No.: 18/383,692

(22) Filed: Oct. 25, 2023

(51) Int. Cl. B24B 23/03; B25F 5/02

(52) U.S. Cl. CPC B24B 23/03; B25F 5/02

(57) ABSTRACT

An ergonomic hand-held power tool is disclosed. The hand-held power tool comprising a housing, which includes a tool axis and a drive axis. The housing also includes a rear handle, a switch positioned proximate the rear handle, a fore grip handle, and a thumbrest disposed on an upper side of the housing proximate the fore grip handle. A motor, retained within the housing, which drives a working head via a drive shaft and gearing. The rear handle is generally parallel to the tool axis. The fore grip handle is generally parallel to the drive axis. The thumbrest is generally perpendicular to the tool axis. The hand-held power tool also includes an accessory axis and a removable handle. The accessory axis is generally perpendicular to both the tool axis and the drive axis and the removable handle is generally parallel to the accessory axis.

### BACKGROUND

The present disclosure relates generally to an ergonomic adjustable grip for a hand-held power tool.

Many hand-held power tools provide limited ways to grip, handle, and use the tool. For example, such hand-held power tools typically include a main grip, a switch to actuate the hand-held power tool, and sometimes an integrated secondary grip to allow for two-hand operation of the tool. By way of a specific example, a typical hand-held orbital polishing power tool includes a rear handle, a switch, and a secondary extended handle positioned opposite the rear handle proximate the working head. Such a design, however, does not allow for an alternative ergonomic handling of the hand-held orbital polishing power tool based on an operator's personal preference, working conditions, and/or the working angle of the tool. Consequently, some operators may shift the positioning of their hands to portions of the hand-held power tool not suitable for a controlled operation of that power tool. Moreover, conventional grips for hand-held power tools may require that an operator's hands are positioned in a way such that the operator's forearms are pronated or pronated, resulting in increased risk of fatigue and/or reduced grip strength.

As such, it is beneficial to provide a hand-held power tool including an ergonomic adjustable grip that provides multiple ergonomic ways to safely operate and control the tool based on an operator's personal preference, operating conditions, and or the working angle required of that power tool.

### SUMMARY

An ergonomic and adjustable grip for a hand-held power tool is disclosed, as illustrated by and described in connection with the figures of the present disclosure, and as set forth in the claims.

Specifically, disclosed are embodiments of a hand-held power tool. In one embodiment, the hand-held power tool includes a housing, which comprises: a tool axis, a drive axis, a rear handle, a switch positioned proximate the rear handle, a fore grip handle, and a thumbrest disposed on an upper side of the housing proximate the fore grip handle. The hand-held power tool also includes a motor, retained within the housing, and a working head driven by the motor via a drive shaft and gearing. In such an embodiment, the rear handle is generally parallel to the tool axis, the fore grip handle is generally parallel to the drive axis, and the thumbrest is generally perpendicular to the tool axis.

In another embodiment, the tool axis and the drive axis are generally perpendicular. In some embodiments, the rear handle and the fore grip handle are integrated with the housing. In such an embodiment, the fore grip handle includes a fore grip recess operable to ergonomically position an operator's upper extremity. Further, a position of the fore grip handle relative to the thumbrest may provide an ergonomic resting location for an operator's hand.

In another embodiment, the hand-held power tool includes an accessory axis and a removable handle. The accessory axis is generally perpendicular to both the tool axis and the drive axis; and the removable handle is generally parallel to the accessory axis. In such an embodiment, the thumbrest is generally parallel to the accessory axis and is operable to provide a mounting location seat for the removable handle. In an additional embodiment a position of the removable handle relative to the housing is adjustable about the accessory axis.

In a further embodiment of the hand-held power tool, the removable handle includes at least one fastener receiver, the housing includes at least one threaded bore, and the removable handle is operable to be removably fastened to the housing by engaging a threaded fastener with the at least one fastener receiver and the at least one threaded bore. Such an embodiment may further include a tool operable to engage the threaded fastener and a tool storage portion, on the housing, operable to stow the tool on the housing. In one example, the hand-held power tool is a hand-held orbital polishing power tool.

Also disclosed is a hand-held power tool, the hand-held power tool comprising a housing, which includes: a tool axis, an accessory axis, a rear handle; a switch positioned proximate the rear handle, and a removable handle. The hand-held power tool also includes a motor, retained within the housing, and a working head driven by the motor via a drive shaft and gearing. In such an embodiment, the rear handle is generally parallel to the tool axis, and the removable handle is generally parallel to the accessory axis.

In another embodiment, the tool axis and the accessory axis are generally perpendicular. The housing may further comprise an elongated recess disposed in an upper side of the housing. In such an embodiment, the elongated recess is generally parallel to the accessory axis and is operable to provide a mounting location seat for the removable handle. In a further embodiment, the hand-held power tool includes a drive axis and the housing includes a fore grip handle. In such an embodiment, the drive axis is generally perpendicular to both the tool axis and the accessory axis, and the fore grip handle is generally parallel to the drive axis.

In some embodiments, the rear handle and the fore grip handle is integrated with the housing. In such an embodiment, the fore grip handle includes a fore grip recess operable to ergonomically position an operator's upper extremity. Further, the elongated recess may be positioned proximate the fore grip handle such that the elongated recess is operable to provide an ergonomic thumbrest when the removable handle is removed.

In another embodiment, a position of the removable handle relative to the housing is adjustable about the accessory axis. In a further embodiment, the removable handle includes at least one fastener receiver, the housing includes at least one threaded bore, and the removable handle is operable to be removably fastened to the housing by engaging a threaded fastener with the at least one fastener receiver and the at least one threaded bore. Such an embodiment may further include a tool operable to engage the threaded fastener and the housing may include a tool storage portion operable to stow the tool on the housing. In one example, the hand-held power tool is a hand-held orbital polishing power tool.

Also disclosed is a removable handle for a hand-held power tool. The removable handle includes a grip portion and a tool attachment portion. In such an embodiment, the handle is operable to permit the ergonomic operation of the hand-held power in at least a first configuration and a second configuration. The first configuration positions an operator's upper extremity such that the operator's forearm is in a generally neutral position. The second configuration positions the operator's upper extremity to apply leverage along a drive axis through a working head and onto a work surface.

In another embodiment, the tool attachment portion includes at least one fastener receiver for receiving a threaded fastener. And the removable handle is attachable to the hand-held power tool by inserting a threaded fastener through the at least one fastener receiver and engaging the threaded fastener with a housing of the hand-held power tool.

### BRIEF DESCRIPTION OF SEVERAL VIEWS OF THE DRAWINGS

The following is a brief description of the drawings pertaining to the present disclosure, which will be discussed in more detail in the detailed description section below:

FIG. 1 illustrates a partial exploded perspective view of a hand-held power tool showing a removable handle, threaded fasteners, and tool.

FIG. 2 illustrates a side elevation section view, taken along the tool axis in FIG. 1, and showing a motor, gearing, and drive shafts.

FIG. 3 is a diagram of representative body mechanics relevant to operating a hand-held power tool.

FIG. 4 illustrates a perspective view of a hand-held power tool being operated in a first configuration utilizing a fore grip and thumbrest, and shows an operator's hands holding the hand-held power tool.

FIG. 5 illustrates a perspective view of a hand-held power tool being operated in a second configuration including a removable handle and shows an operator's hands holding the hand-held power tool.

FIG. 6 illustrates a perspective view of a hand-held power tool without a removable handle.

FIG. 7 illustrates a side elevation view of a hand-held power tool without a removable handle.

FIG. 8 illustrates a perspective view of a hand-held power tool including a removable handle.

FIG. 9 illustrates a side elevation view of a hand-held power tool including a removable handle.

The foregoing summary, as well as the following detailed description of certain features of the present application, are better understood when read in conjunction with the appended drawings. For the purposes of illustration, certain features are shown in the drawings. It should be understood, however, that the claims are not limited to the arrangements shown in the attached drawings. Although specific features of various embodiments may be shown in some drawings and not in others, this is for convenience only. Any feature of any drawing may be referenced and/or claimed in combination with any feature of any other drawing.

Unless otherwise indicated, the drawings provided herein are meant to illustrate features of embodiments of the disclosure. These features are believed to be applicable in a wide variety of applications comprising one or more embodiments of the disclosure. As such, the drawings are not meant to include all conventional features known by those of ordinary skill in the art to be required for the practice of the embodiments disclosed herein.

### DETAILED DESCRIPTION

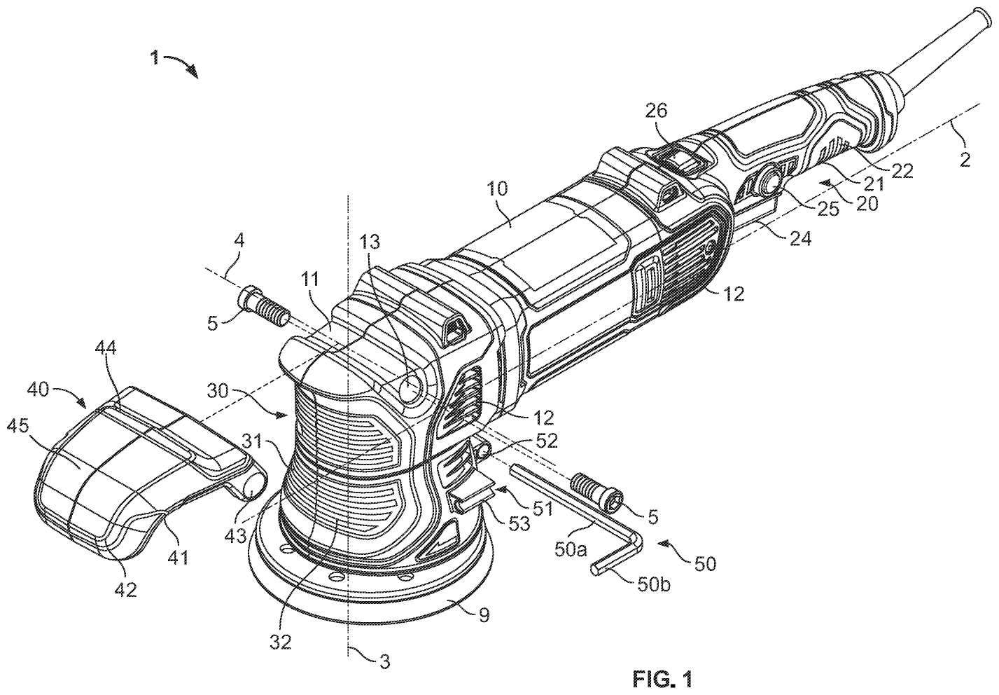

FIG. 1 shows a partial exploded view of a hand-held power tool 1. The illustrated embodiment shows a hand-held orbital polisher power tool, but it is understood that the present disclosure applies equally to any and all other applicable hand-held power tools. The hand-held power tool 1 comprises a housing 10 defining a tool axis 2, drive axis 3, and accessory axis 4. As shown in the figures, the tool axis 2 is generally horizontal and runs in-line with the housing 10 of the hand-held power tool 1. It is understood that the terms “in-line” and “generally parallel” as used in the present disclosure mean that two components appear to be and are substantially parallel (i.e., 0 degree angle) but that some angle less than plus or minus 20 degrees is permitted between those two components. The drive axis 3, as illustrated, is generally vertical and generally perpendicular to the tool axis 2. It is understood that the term “generally perpendicular” as used in the present disclosure means that two components appear to be and are substantially perpendicular (i.e., 90 degree angle) but that some angle less than plus or minus 20 degrees from 90 degrees is permitted between those two components. It is further understood that the present disclosure does not limit the drive axis 3 to being generally perpendicular to the tool axis 2, and that other arrangements are contemplated. The accessory axis 4 is generally perpendicular to both the tool axis 2 and the drive axis 3. The present disclosure utilizes the reference frame of the tool axis 2, drive axis 3, and accessory axis 4 to explain the physical relationship, orientations, and/or arrangements of the various components of a hand-held power tool's 1 grip, which enable an ergonomic operation of the hand-held power tool 1.

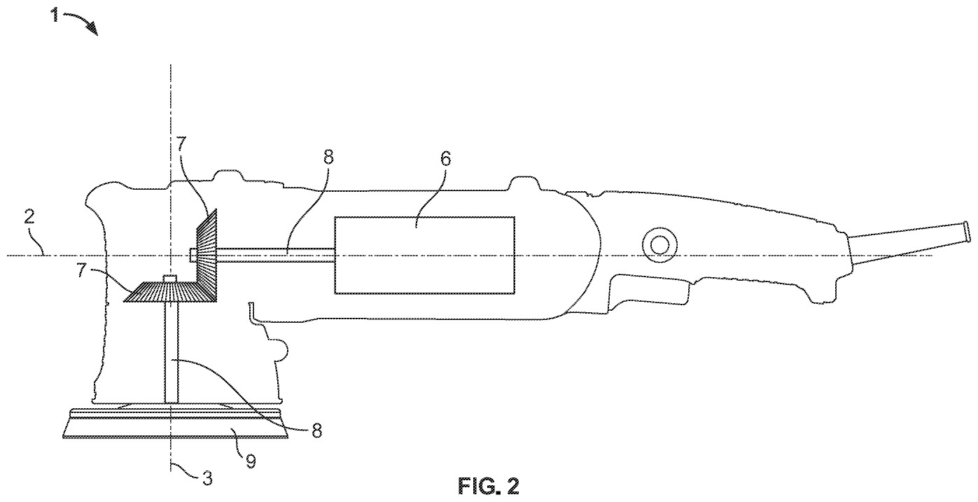

As shown in FIGS. 1 and 2, the hand-held power tool 1 comprises a housing 10 which encloses a motor 6, gearing 7, and one or more drive shafts(s) 8. The housing 10 can be made from any suitable material including, for example, plastic, metal, or a combination thereof. The motor 6 is positioned generally parallel to or in-line with the tool axis 2. The motor 6 creates rotational force when connected to a power source (not shown), which rotates one of the drive shaft(s) 8. The optional gearing 7 is operable to alter the direction, speed, or torque of the rotational force. In the illustrated embodiment, the hand-held power tool 1 includes a motor drive shaft 8, in-line with the tool axis 2, coupled to the motor 6 at one end and coupled to gearing 7 at the opposite end. The gearing 7 may comprise, for example, a bevel gear arrangement. As illustrated, the bevel gear arrangement has a gear ratio of 1, but it is understood that the present disclosure contemplates other gear ratios. A secondary drive shaft 8, in-line with the drive axis 3, is also coupled to the gearing 7 at one end and coupled to a working head 9 at the opposite end (such that the working head 9 is driven by the motor 6). The working head 9, may include, but is not limited to, an orbital polishing pad, sanding pad, or drill chuck. The gearing 7, and specifically the bevel gear arrangement, is operable to change the direction of the rotational force generated by the motor 6, rotating first about the tool axis 2, to rotate about the drive axis 3 (in the illustrated embodiment, an approximately 90 degree change, but other directional changes are also contemplated). Finally, as shown in the illustrated embodiment, because the motor 6, gearing 7, and drive shaft 8, are in-line with the tool axis 2, the center of mass of these components is also substantially positioned along the tool axis 2.

In the illustrated embodiment, the housing 10 of the hand-held power tool 1 further comprises a rear handle 20, a fore grip handle 30, and a removable handle 40. The rear handle 20 is generally integrated with the housing 10 (but could also be a non-integrated component) and positioned at a rear end of the housing 10. Further, the rear handle 20 is generally parallel and in-line with the tool axis 2. The rear handle 20, as illustrated, includes a recess 21 and textured surface 22. The rear handle textured surface 22 may include a pattern of grooves and be made of a rubberized material. As such, the rear handle textured surface 22 contributes to an operator having a more firm grip on the rear handle 20 of the hand-held power tool 1 regardless of environmental conditions (e.g., moisture, dirt, etc.).

Adjacent to the rear handle 20 is a switch 24. In the exemplary embodiment, the switch 24 is a spring loaded trigger switch. In alternative embodiments, the switch 24 may be a slider switch, capacitive touch switch, or any other type of switch operable to activate the motor 6 of the hand-held power tool 1. Optionally, the hand-held power tool 1 may also include a lock-out 25 and a speed selector 26. The lock-out 25 is operable to lock the switch 24 in an engaged position such that the operator is not required to apply pressure to the switch 24 the entire time while activating and using the hand-held power tool 1. Therefore, the lock-out 25 may contribute to reducing operator fatigue during operational periods of the hand-held power tool 1. The speed selector 26 is operable to alter the speed of the motor 6. In a preferred embodiment, the switch 24, lock-out 25, and speed selector 26 are all positioned adjacent and proximate to the rear handle 20, such that the operator is able to engage and disengage each of the switch 24, lock-out 25, and speed selector 26 without having to substantially reposition their hands on the rear handle 20.

Further, as shown in the illustrated embodiment, the fore grip handle 30 is generally integrated with the housing 10 (but likewise could be a non-integrated component) and positioned at a fore end of the housing 10 adjacent the working head 9 of the hand-held power tool 1. The fore grip handle 30 is generally parallel to the drive axis 3. As illustrated, the fore grip handle 30 is generally perpendicular to the tool axis 2 and rear handle 20, however other non-perpendicular arrangements are contemplated. The fore grip handle 30, includes a recess 31 and textured surface 32. The fore grip textured surface 32 may include a pattern of grooves and be made of a rubberized material. As such, the fore grip textured surface 32 contributes to the operator having a more firm grip on the fore grip handle 30 of hand-held power tool 1 regardless of environmental conditions (e.g., moisture, dirt, etc.).

The removable handle 40 attaches (i.e., is removably fastened) to the housing 10 proximate to and adjacent the fore grip handle 30. The removable handle 40 is generally parallel to the accessory axis 4. In some embodiments, the removable handle 40 is adjustable and operable to be rotated about accessory axis 4. In the exemplary embodiment, the removable handle 40 is a duckbill handle. In alternative embodiments, the removable handle 40 may be another configuration in which the operator is able to grip the removable handle 40 with one hand and the rear handle 20 with the other hand. The removable handle 40 can be made from any suitable material including, for example, plastic, metal, or a combination thereof. As illustrated, the removable handle 40 includes a lower recess 41, a textured surface 42, and a lip 44. The removable handle textured surface 42 may include a pattern of grooves and be made of a rubberized material. As such, the removable handle 40 textured surface 42 contributes to the operator having a more firm grip on the removable handle 40, when it is attached to the hand-held power tool 1, regardless of environmental conditions (e.g., moisture, dirt, etc.).

The removable handle 40 attaches to the housing 10 via one or more threaded fastener(s) 5. As illustrated, the removable handle 40 includes two fastener receivers 43 (i.e., tool attachment portion), operable to receive the threaded fastener(s) 5. Further, the housing 10 includes corresponding two threaded bores 13, positioned generally concentrically and in-line with the accessory axis 4. The removable handle 40 is positioned within an elongated recess 11 disposed in the housing 10, such that the two fastener receivers 43 concentrically line up with the corresponding two threaded bores 13 in the housing 10. The elongated recess 11 is configured to receive the removable handle 40 ensuring that the removable handle 40 is aligned properly with the threaded bores 13 when positioned in the elongated recess 11. At least one of the threaded fasteners 5 is inserted through each of the fastener receivers 43 of the removable handle 40 and rotatably engaged with the threaded bores 13. For example, the threaded fastener 5 is an Allen bolt and a tool 50 (e.g., an Allen wrench) is used to turn (i.e., rotatably engage) the Allen bolt to secure the removable handle 40 to the housing 10 of the hand-held power tool 1. In alternative embodiments, other fasteners 5 may be used to secure the removable handle 40 to the housing 10 of the hand-held power tool 1, such as pins and rings, rods and collars, etc.

In the exemplary embodiment, the housing 10 includes a tool storage portion 51, operable to stow or retain the tool 50 on the housing 10. The tool storage portion 51 is advantageous for the operator to avoid losing the tool 50 between uses of the hand-held power tool 1. When the tool 50 is properly retained in the tool storage portion 51, the tool 50 is available when required to attach, adjust, or remove the removable handle 40. In the illustrated embodiment, where the tool 50 is an Allen wrench, the tool storage portion 51 comprises a tool retainer 52 and a clip 53. A typical Allen wrench has an elongated handle end 50a and a shortened tool end 50b that form an L-shape. The tool retainer 52 is operable to receive the elongated handle end 50a and the clip 53 is operable to receive and retain the shortened tool end 50b. Together the tool retainer 52 and clip 53 are operable to retain the tool 50 to the housing 10. In alternative embodiments, the hand-held power tool 1 may not include the tool storage portion 51 extending from the housing 10.

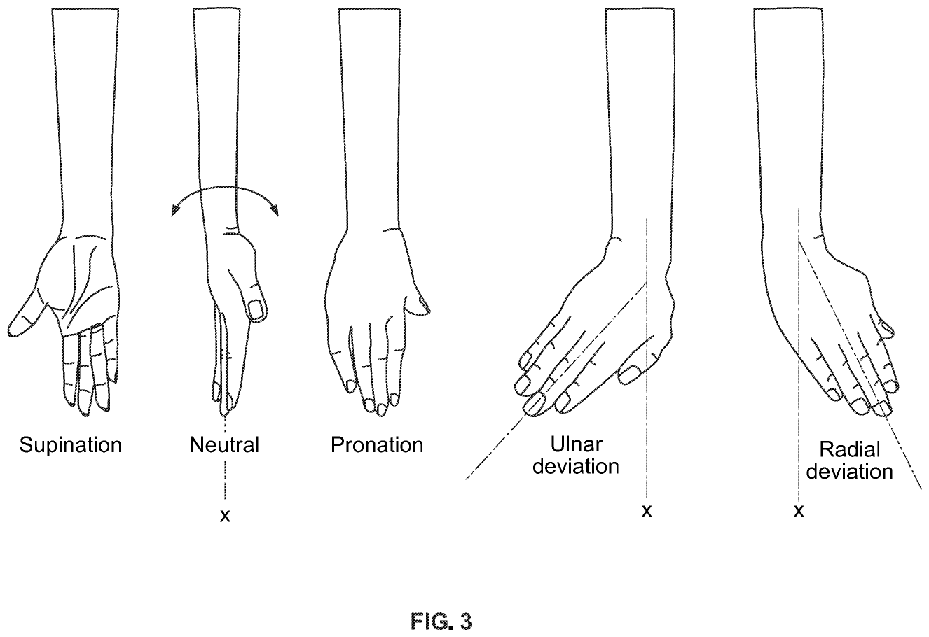

FIG. 3 illustrates relative positioning and movement of a human upper extremity (i.e., arm), and specifically, the forearm, wrist, and hand. As shown, the forearm is capable of moving into pronation or supination. Starting from a neutral position as shown, the forearm can rotate about the x-axis into either a supinated position or a pronated position. Similarly, the forearm can rotate about the x-axis from the pronated position to the supinated position, or, from the supinated position to the pronated position. The forearm muscles that produce supination include the supinator, biceps brachii, and brachioradialis (from the supinated position). The forearm muscles that produce pronation include the pronator teres, pronator quadratus, flexor carpi radialis, and brachioradialis (from the pronated position). Due to the orientation within the forearm and the size of the muscles that produce supination as compared to the muscles that produce pronation, the muscles that produce supination are much stronger and more resistant to fatigue. For pronation, the smaller muscles must work harder to maintain the forearm in the pronated position as compared to the muscles that maintain the forearm in the supinated position. These pronator muscles also fatigue quicker than the muscles that produce supination as a result of their size and orientation within the forearm. In the neutral position shown in FIG. 3, the muscles that produce supination and pronation can work together in concert to keep the forearm in the neutral position, thereby providing for increased resistance to fatigue and increased grip strength of the hand. As such, grip strength of the hand and resistance to fatigue is greater when the forearm is in the neutral position as compared to when the forearm is in the pronated position.

Also, as shown in FIG. 3, the wrist is capable of moving into ulnar deviation and radial deviation. Starting from a neutral position, the wrist can pivot about the x-axis into either an ulnarly deviated position or a radially deviated position. Similarly, the wrist can pivot about the x-axis from the ulnarly deviated position to the radially deviated position, or, from the radially deviated position to the ulnarly deviated position. The muscles that produce ulnar deviation include the flexor carpi ulnaris and extensor carpi ulnaris. The muscles that produce radial devation include the flexor carpi radialis, extensor carpi radialis longus, extensor carpi radialis brevis, and abductor pollicis longus. Due to the orientation within the forearm and wrist and the size of the muscles that produce ulnar deviation as compared to the muscles that produce radial deviation, the muscles that produce ulnar deviation are much stronger and more resistant to fatigue. Additionally, as shown, the wrist is capable of a greater degree of range of motion when moving away from the x-axis in ulnar deviation as compared to the range of motion achieved when moving away from the x-axis in radial deviation. As such, gripping and holding objects in the ulnarly deviated position is easier than gripping and holding objections in the radially deviated position due to the increased available range of motion. Therefore, designing a hand-held power tool to account for the biomechanics of the forearm, wrist, and hand leads to a more ergonomic tool that allows for maximum grip strength and higher resistance to fatigue.

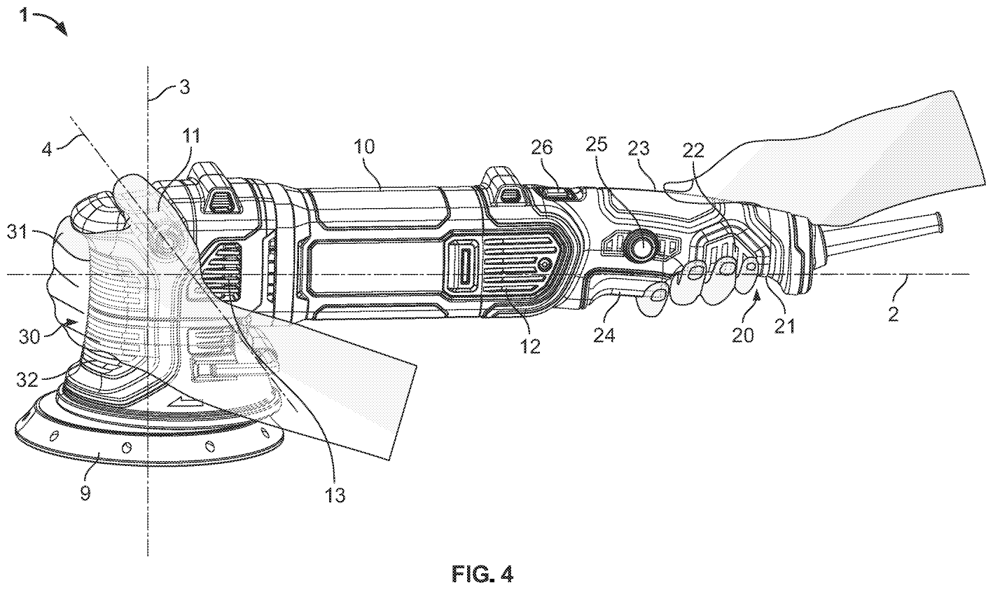

FIG. 4 shows the hand-held power tool 1, in a first configuration, being handled by the operator using the rear handle 20 and the fore grip handle 30 with the removable handle 40 removed. As illustrated, representative operator hands (shown in gray shading) are shown gripping the rear handle 20 and fore grip handle 30. As illustrated, the operator's hands are positioned such that both of the operator's forearms are in a generally neutral position. Such an alignment, substantially eliminates supination and pronation of the operator's forearms, and therefore, contributes to reduce fatigue, maintain grip strength, and provides for ergonomic operation of the hand-held power tool 1. Further as illustrated, the design and configuration of the rear handle 20, positions an operator's forearm in a neutral position and the operator's wrist in a slightly ulnarly deviated position. Research has shown that grip strength is greatest when the forearm is in neutral and the wrist is slightly ulnarly deviated by a few degrees. Thus, the ergonomic handle shape disclosed herein contributes to ensuring an operator is able to apply and maintain maximum grip strength on the rear handle 20.

Further, because the rear handle 20 is generally in-line and parallel with the tool axis 2, when the operator grips the rear handle 20, the operator's hand is holding the hand-held power tool 1 about the tool axis 2. Likewise, because the fore grip handle 30 is generally parallel to the drive axis 3, when the operator grips the fore grip handle 30, the operator's hand is holding the hand-held power tool 1 about the drive axis 3. Such an arrangement may improve an operator's ability to control and/or maintain balance of the hand-held power tool 1 (e.g., applying a counter moment force) where the motor 6 is generating a significant amount of torque and/or the working head 9 is spinning at a high rate. For example, as the working head 9 is spinning clock-wise and is applied to a static work surface, friction and/or resistance between the work surface and the working head 9 may result in some opposite rotational force being applied onto the hand-held power tool 1 forcing the hand-held power tool 1 to rotate counter-clockwise about the drive axis 3. To maintain control of the hand-held power tool 1, the operator must generate a moment force in counter-clockwise rotation.

Thus, the positioning of the operator's hands is imperative to maintain control of the hand-held power tool 1. In the exemplary embodiment, one of the operator's hands is positioned about the drive axis 3 adjacent the working head 9, and the other hand is positioned about the tool axis 2. Therefore, the operator may find it easier to control the moment force generated by the motor 6 and the working head 9 because the hand-held power tool 1 would rotate about the drive axis 3. Thus, the operator's hand positioned about the drive axis 3 would be in a more stable position regardless of any moment force generated by the hand-held power tool 1. Consequently, even if the drive axis 3 has a different orientation than the illustrated embodiment (i.e., an angle other than 90 degrees from the tool axis 2), one of the operator's hands will be in the stable position about the drive axis 3. With one hand effectively “anchored” about the drive axis 3, any counter-moment force being required to maintain control of the hand-held power tool 1 may be applied solely via the rear handle 20. Moreover, because the operator's hand is gripping the rear handle 20 about the tool axis 2, the weight of the hand-held power tool 1 is evenly distributed, thereby decreasing the amount of unwanted additional rotation or unbalance when applying a counter-moment force.

Further, as shown in FIG. 4, the rear handle 20 and the fore grip handle 30 are both designed to ergonomically position the operator's upper extremity. For example, the rear handle 20 is shaped to accommodate the shape of the operator's hand ensuring that the operator may ergonomically and comfortably grip the rear handle 20. Specifically, the rear handle 20 may include a slight bend 23 (as illustrated) which conforms to the operator's palm and/or thumb. Additionally, the illustrated embodiment depicts a rear handle recess 21, operable for receiving at least some or all of the operator's fingers. Further, as mentioned above, the positioning of the switch 24, lock-out 25, and/or speed selector 26 relative to the rear handle 20 is such that the operator may access each of the switch 24, lock-out 25, and/or speed selector 26 without having to substantially shift their grip on the rear handle 20. Likewise, the rear handle 20 includes the textured surface 22, which contributes to the operator maintaining control of the hand-held power tool 1.

Likewise, the fore grip handle 30 is shaped to accommodate the shape of the operator's hands ensuring that the operator is able to ergonomically and comfortably grip the fore grip handle 30. Specifically, the fore grip handle 30 includes a fore grip recess 31, operable for receiving the operator's palm and/or some or all the operator's fingers. Further, the hand-held power tool 1 includes the elongated recess 11 positioned on an upper side of the hand-held power tool 1, which is operable for receiving the operator's thumb (i.e., a thumbrest). The positioning of the elongated recess 11 relative to the fore grip handle 30 provides an ergonomic and comfortable resting location for the operator's hand. In other words, the positioning of the elongated recess 11 relative to the fore grip handle 30 is such that when the operator grips the fore grip handle 30, the operator's thumb is naturally positioned in the elongated recess 11 and the operator's palm and/or other fingers are naturally positioned in the fore grip recess 31. Additionally, the fore grip handle 30 and/or elongated recess 11 includes the textured surface 32, which contributes to the operator maintaining control of the hand-held power tool 1. In combination, the shape, texture, and location of the rear handle 20 and fore grip handle 30 contributes to the operator being able to ergonomically, comfortably, and firmly grip and maintain control of the hand-held power tool 1.

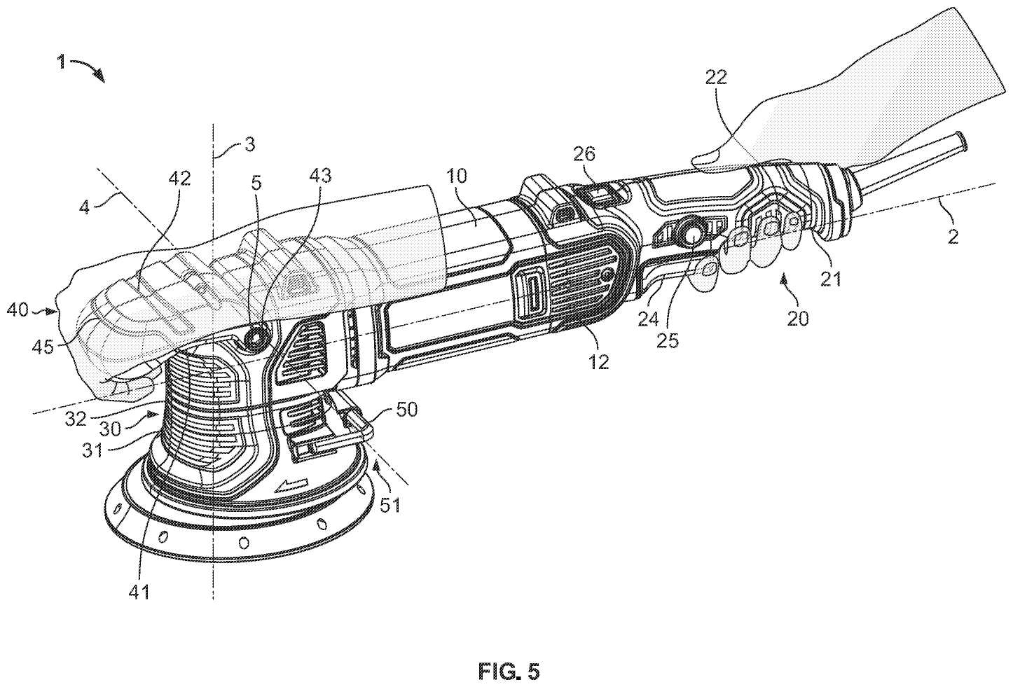

FIG. 5 shows the hand-held power tool 1, in a second configuration, being handled by the operator using the rear handle 20 and the removable handle 40. The positioning of the operator's hand on the rear handle 20 is substantially consistent with the disclosure above-maintaining the operator's forearm in a neutral position and wrist in a slightly ulnarly deviated position. The operator's hand holding the removable handle 40 is positioned such that the operator's forearm is in a pronated position (palm of the handing facing in a downward direction). While pronation may result in quicker fatigue of the forearm muscles, the positioning of the removable handle 40 relative to the working head 9 has certain other benefits. For example, as illustrated, the operator holding the removable handle 40 is able to apply more leverage and downward force along the drive axis 3, onto work surfaces. Specifically, due to the positioning of the removable handle 40 being parallel to the accessory axis 4, which is perpendicular to both the tool axis 2 and the drive axis 3, the operator is able to push down on the hand-held power tool 1 in a balanced manner utilizing the center of mass of the hand-held power tool 1. Moreover, in such an arrangement, the operator is able to utilize both the weight of the hand-held power tool 1 (most of the weight being in front of the tool due to the positioning of the gearing 7, drive shaft(s) 8, motor 9, and working head 9) and the operator's own mass. In alternative embodiments, the removable handle 40 may be positioned at varying angles relative to the tool axis 2 to accommodate the operator's comfort preference. By contrast, where the operator's hand is positioned as depicted in FIG. 4, the operator must pull down on the hand-held power tool 1 to apply downward force.

Further, as shown in FIG. 5, the removable handle 40 is designed to ergonomically position the operator's upper extremity. For example, the removable handle 40 may include a curved portion 45 which conforms to the operator's palm. Additionally, the removable handle 40 includes the lower recess 41, operable for receiving some or all of the operator's fingers. Likewise, the removable handle includes the textured surface 42, which contributes to the operator maintaining control of the hand-held power tool 1. In combination, the shape, texture, and location of the removable handle 40 contributes to the operator being able to ergonomically, comfortably, and firmly grip and maintain control of the hand-held power tool.

Thus, the flexibility provided by the present disclosure enables for the ergonomic operation of the hand-held power tool 1, by reducing fatigue and maintaining grip strength, while at the same time enabling the operator to alter the geometry of the handle shape for operations requiring more force being applied to the hand-held power tool 1 and work surface. Consequently, the operator has maximum control over the hand-held power tool 1, on the operator's personal preference, operating conditions, and/or the working angle required of the hand-held power tool 1. Finally, the operating configurations depicted in FIGS. 4 and 5 are ambidextrous, meaning the benefits described above apply equally to both right-handed and left-handed operators.

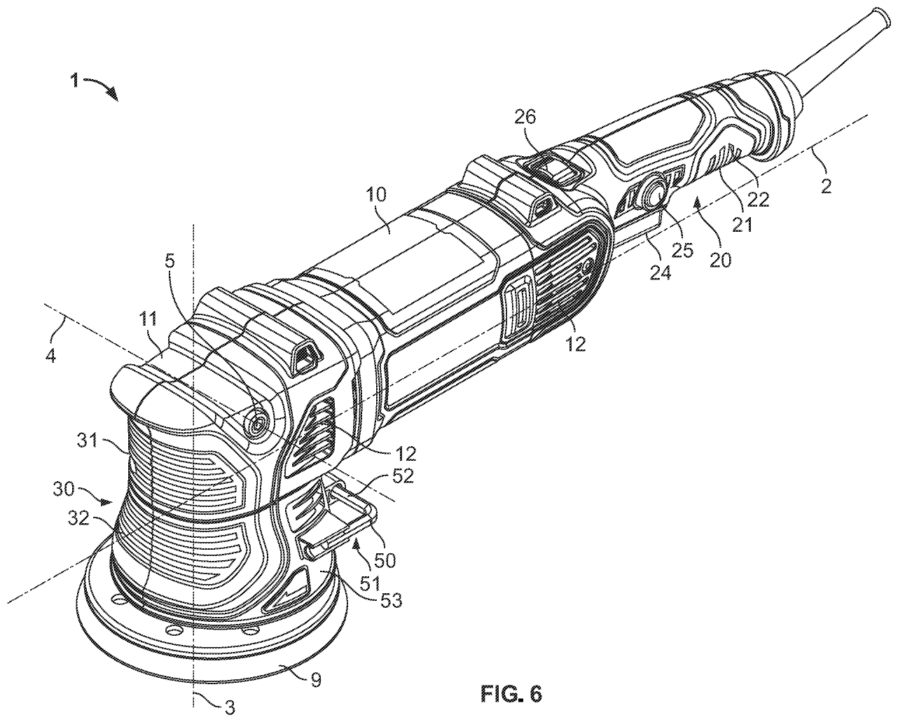

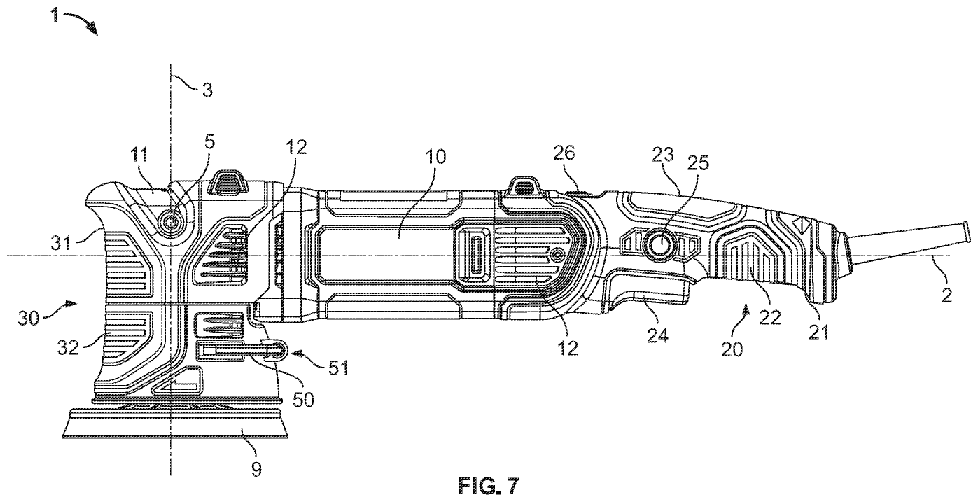

FIGS. 6 and 7 show the hand-held power tool 1 in the configuration described above with respect to FIG. 4 (using the rear handle 20 and fore grip handle 30) without the hands for clarity of illustration. It is worth noting that the positioning of the operator's hands is not limited to the discussion described above with respect to FIG. 4. For example, the operator may place a hand on the top of the hand-held power tool 1 and apply downward force along the drive axis. FIGS. 6 and 7 provide detailed additional views of the curvature and shape of the rear handle 20 and the rear handle recess 21; the fore grip handle 30 and fore grip handle recess 31; and the elongated recess 11.

Further, as illustrated in FIGS. 6 and 7, the threaded fasteners 5 may engage with (screwed into) the threaded bore 13 in the housing 10 even when the removable handle 40 is not attached to the hand-held power tool 1. This has the benefit of decreasing the likelihood the threaded fasteners 5 are lost and are available for use when needed to install the removable handle 40. Further, when the threaded fasteners 5 are fully engaged the threaded bore 13, the head of the threaded fasteners 5 are substantially co-planar with the nearby housing 10 such that the threaded fasteners 5 do not interfere with the operator's hand gripping the hand-held power tool 1. Likewise, the tool 50 is retained in the tool storage portion 51 to not interfere with the operator's hands while using the hand-held power tool 1.

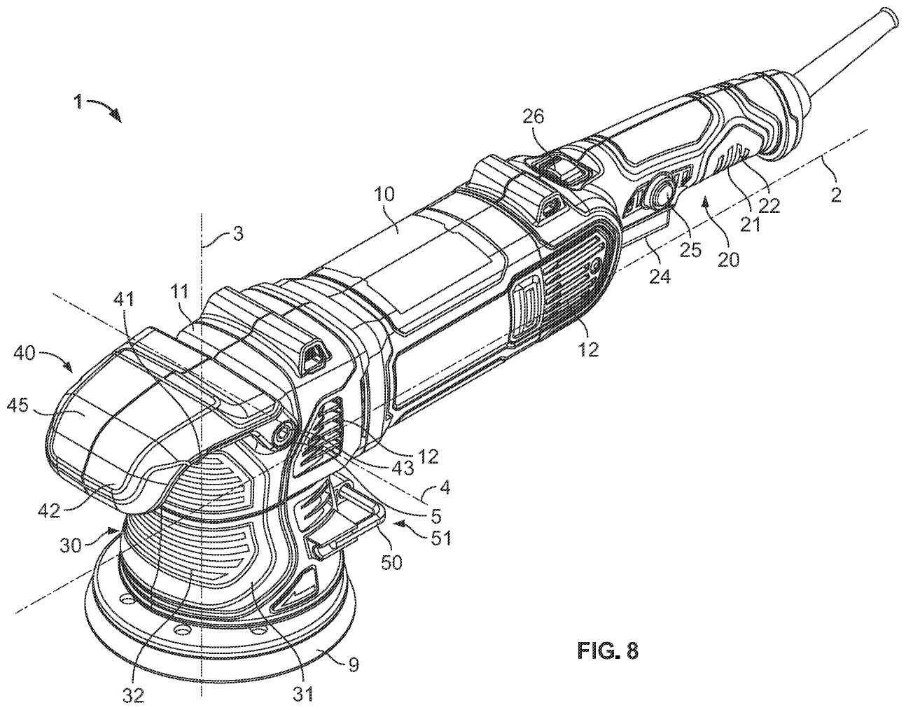

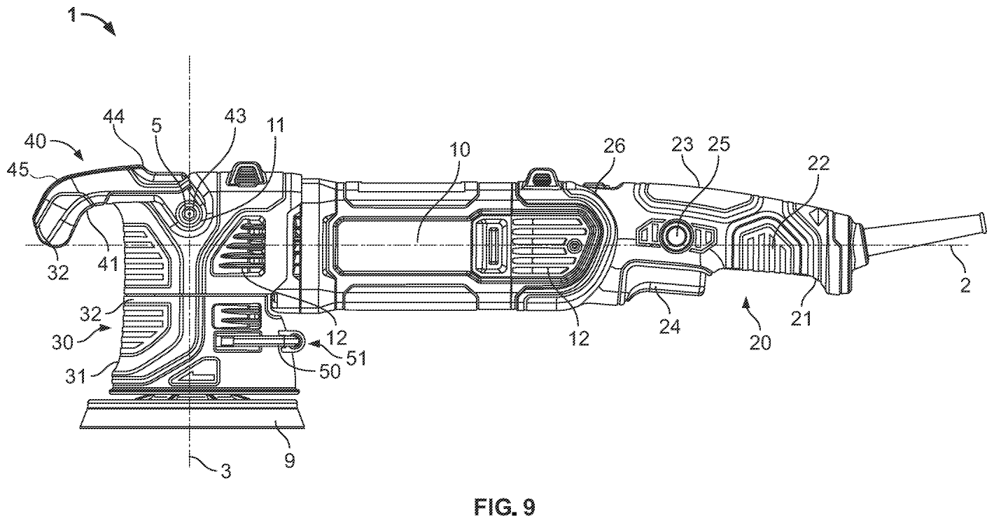

FIGS. 8 and 9 show the hand-held power tool 1 in the configuration described above with respect to FIG. 5 (using the rear handle 20 and removable handle 40) without the hands for clarity of illustration. It is again worth noting that the positioning of the operator's hands is not limited to the discussion described above with respect to FIG. 5. For example, because of the shape and positioning of the removable handle 40 (and specifically the recess 41), the operator may grip the fore grip handle 30 even with the removable handle 40 installed. Further, a lip 44 on the removable handle 40 may provide a thumbrest when the removable handle 40 is installed, and the operator is gripping the fore grip handle 30. Finally, FIGS. 8 and 9 provide detailed views of the curvature and shape of the removable handle 40. Specifically, as shown, the removable handle 40 is shaped to conform to the hand and/or fingers of the operator when the fingers are curled down and gripping the removable handle 40.

The present described disclosure is described in such full, clear, concise, and exact terms as to enable any person skilled in the art to which it pertains to practice the same. It is to be understood that the foregoing described preferred aspects of the disclosure and that modifications may be made therein without departing from the spirit of scope of the disclosure as set forth in the appended claims. The scope of the following claims is to be accorded the broadest interpretation to encompass all such modifications and equivalent structures and functions. Therefore, it is intended that the application not be limited to the particular aspects disclosed, but that the application will include all aspects falling within the scope of the appended claims.

What is claimed:

1. A hand-held power tool, the hand-held power tool comprising:
a housing, the housing including:
a tool axis;
a drive axis;
a rear handle;
a switch positioned proximate the rear handle;
a fore grip handle; and
a thumbrest disposed on an upper side of the housing proximate the fore grip handle;
a motor, retained within the housing; and
a working head driven by the motor via a drive shaft and gearing, wherein:
the rear handle is generally parallel to the tool axis;
the fore grip handle is generally parallel to the drive axis;
and the thumbrest is generally perpendicular to the tool axis.

2. The hand-held power tool of claim 1, wherein the tool axis and the drive axis are generally perpendicular.

3. The hand-held power tool of claim 1, wherein the rear handle and the fore grip handle are integrated with the housing.

4. The hand-held power tool of claim 3, wherein the fore grip handle includes a fore grip recess operable to ergonomically position an operator's upper extremity.

5. The hand-held power tool of claim 4, wherein a position of the fore grip handle relative to the thumbrest provides an ergonomic resting location for an operator's hand.

6. The hand-held power tool of claim 1, further comprising an accessory axis and a removable handle, wherein:
the accessory axis is generally perpendicular to both the tool axis and the drive axis; and
the removable handle is generally parallel to the accessory axis.

7. The hand-held power tool of claim 6, wherein the thumbrest is generally parallel to the accessory axis and is operable to provide a mounting location seat for the removable handle.

8. The hand-held power tool of claim 6, wherein a position of the removable handle relative to the housing is adjustable about the accessory axis.

9. The hand-held power tool of claim 6, wherein:
the removable handle includes at least one fastener receiver;
the housing includes at least one threaded bore, and
the removable handle is operable to be removably fastened to the housing by engaging a threaded fastener with the at least one fastener receiver and the at least one threaded bore.

10. The hand-held power tool of claim 9, further comprising a tool operable to engage the threaded fastener.

11. The hand-held power tool of claim 10, wherein the housing further comprises a tool storage portion operable to stow the tool on the housing.

12. The hand-held power tool of claim 1, wherein the hand-held power tool is a hand-held orbital polishing power tool.

13. A hand-held power tool, the hand-held power tool comprising:
a housing, the housing including:
a tool axis;
an accessory axis;
a rear handle;
a switch positioned proximate the rear handle; and
a removable handle;
a motor, retained within the housing; and
a working head driven by the motor via a drive shaft and gearing, wherein:
the rear handle is generally parallel to the tool axis; and
the removable handle is generally parallel to the accessory axis.

14. The hand-held power tool of claim 13, wherein the tool axis and the accessory axis are generally perpendicular.

15. The hand-held power tool of claim 13, wherein the housing further comprises an elongated recess disposed in an upper side of the housing, wherein the elongated recess is generally parallel to the accessory axis and is operable to provide a mounting location seat for the removable handle.

16. The hand-held power tool of claim 13, further comprising a drive axis and wherein the housing further comprises a fore grip handle, wherein:
the drive axis is generally perpendicular to both the tool axis and the accessory axis; and
the fore grip handle is generally parallel to the drive axis.

17. The hand-held power tool of claim 16, wherein the rear handle and the fore grip handle are integrated with the housing.

18. The hand-held power tool of claim 17, wherein the fore grip handle includes a fore grip recess operable to ergonomically position an operator's upper extremity.

19. The hand-held power tool of claim 16, wherein the elongated recess is positioned proximate the fore grip handle such that the elongated recess is operable to provide an ergonomic thumbrest when the removable handle is removed.

20. The hand-held power tool of claim 13, wherein a position of the removable handle relative to the housing is adjustable about the accessory axis.

21. The hand-held power tool of claim 13, wherein:
the removable handle includes at least one fastener receiver;
the housing includes at least one threaded bore, and
the removable handle is operable to be removably fastened to the housing by engaging a threaded fastener with the at least one fastener receiver and the at least one threaded bore.

22. The hand-held power tool of claim 21, further comprising a tool operable to engage the threaded fastener.

23. The hand-held power tool of claim 22, wherein the housing further comprises a tool storage portion operable to stow the tool on the housing.

24. The hand-held power tool of claim 13, wherein the hand-held power tool is a hand-held orbital polishing power tool.

25. A removable handle for a hand-held power tool, the removable handle comprising:
a grip portion and a tool attachment portion,
wherein the handle is operable to permit the ergonomic operation of the hand-held power in at least a first configuration and a second configuration;
the first configuration positions an operator's upper extremity such that the operator's forearm is in a generally neutral position; and
the second configuration positions the operator's upper extremity to apply leverage along a drive axis through a working head and onto a work surface.

26. The removable handle of claim 25, wherein:
the tool attachment portion includes at least one fastener receiver for receiving a threaded fastener and wherein the removable handle is attachable to the hand-held power tool by inserting a threaded fastener through the at least one fastener receiver and engaging the threaded fastener with a housing of the hand-held power tool.
